(19) United States
(12) Patent Application Publication
(10) Pub. No.: US 2018/0191640 A1
(43) Pub. Date: Jul. 5, 2018

(54) ACTION REFERENCES

(71) Applicant: Hewlett Packard Enterprise Development LP, Houston, TX (US)

(72) Inventors: Claudio Enrique Viquez Calderon, Heredia (CR); Pedro Elias Alpizar Salas, Heredia (CR)

(21) Appl. No.: 15/736,193

(22) PCT Filed: Jun. 30, 2015
(86) PCT No.: PCT/US2015/038418

§ 371 Date: Dec. 13, 2017

(51) Int. Cl. H04L 12/935; H04L 12/879; H04L 12/721; H04L 12/741

(52) U.S. Cl. CPC H04L 49/3063; H04L 45/745; H04L 45/38; H04L 49/901

(57) ABSTRACT

Examples disclosed herein relate to action reference instructions to identify a plurality of actions associated with a data element, create a pointer to an action set comprising a list of the plurality of actions, associate the pointer to the action set with the data element, follow the pointer to retrieve the plurality of actions associated with the data element according to the action set, and perform each of the plurality of actions on the data element

### BACKGROUND

In some situations, data elements such as network packets may be processed through a pipeline that performs a series of actions on the data element. These actions may modify the contents of the element, create copies of the element, and/or route the data element to various processing nodes prior to delivery and/or output of the data element at a final destination.

### BRIEF DESCRIPTION OF THE DRAWINGS

In the accompanying drawings, like numerals refer to like components or blocks. The following detailed description references the drawings, wherein:

FIG. 1 is a block diagram of an example action reference device;

FIG. 2 is a flowchart of an example of a method for providing action references;

FIG. 3 is a block diagram of an example system for providing action references using flow tables; and

FIG. 4 is a block diagram of an example system for providing action references.

### DETAILED DESCRIPTION

As described above, data elements may be subjected to a series of actions prior to final delivery and/or output. For example, packets may be transmitted into a network where the packets may be subjected to various processing, copying, storage, and/or routing actions prior to delivery to a destination (e.g., another computer) connected to the network. In some situations, the number and complexity of the actions may become both complicated and repetitive. For example, a series of packets all bound from the same originating computer for a particular destination computer may require backup copies to be stored at a network attached storage, a log message to be generated, an error correction code to be calculated, a routing instruction across a switch to be determined, and a re-encapsulation of each packet to be performed. Creation of an action set comprising references to executable objects for each of the actions for this flow of packets increases the efficiency of the network by not forcing each packet to be evaluated at each stage of the flow to determine which actions need to be performed. Further, adding a pointer to the action set in a data field of the packet reduces the overhead needs because each packet may be associated with a single pointer that can be copied for each packet instead attaching the entire set of actions each time. The pointer may then be followed so that each packet's actions may be retrieved from the references of the action set and performed at a location that may be ideally situated in terms of resource capacity and/or connectivity to different segments of the network.

In some implementations, data elements such as packets on an OpenFlow-enabled network may utilize action references. The OpenFlow architecture provides an Application Programming Interface (API) that allows for a programmable pipeline of actions that may be performed on packets as they pass through a network node, such as a switch. Each packet accumulates actions to be executed at the end of the pipeline, such as forwarding, packet modifications, quality of service (QOS) controls, counters, logging etc. These actions may be stored as entries in flow tables within the node. As the packet moves through the pipeline, references to actions within the flow tables may be added to an action set for the packet and a pointer to the action set may be associated with the packet. When the packet reaches the end of the pipeline, before exiting the node, the actions may be retrieved via the references in the action set and the actions performed on the packet.

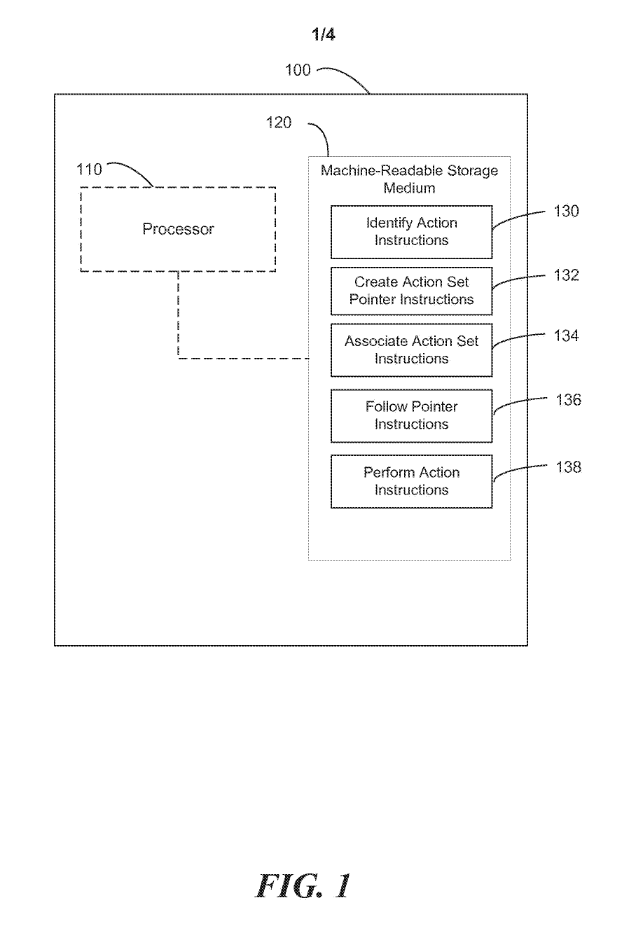

Referring now to the drawings, FIG. 1 is a block diagram of an example action reference device 100 consistent with disclosed implementations. Action reference device 100 may comprise a processor 110 and a non-transitory machine-readable storage medium 120. Action reference device 100 may comprise a computing device such as a server computer, a desktop computer, a laptop computer, a handheld computing device, a smart phone, a tablet computing device, a mobile phone, a network device (e.g., a switch and/or router), or the like.

Processor 110 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 120. In particular, processor 110 may fetch, decode, and execute a plurality of identify action instructions 130, create action set pointer instructions 132, and associate action set instructions 134, follow pointer instructions 136, and perform action instructions 138 to implement the functionality described in detail below.

Executable instructions may comprise logic stored in any portion and/or component of machine-readable storage medium 120 and executable by processor 110. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Identify action instructions 130 may identify a plurality of actions associated with a data element. The data element may comprise, for example, a network packet such as may be associated with an OpenFlow-enabled network. The actions may comprise, for example, routing controls, logging instructions, and/or modification instructions (e.g., re-encoding for different network protocols and/or modification of different fields within the data element).

The data element may be evaluated to identify which, if any, actions need to be performed with respect to the data element. The action may be performed by an executable object stored in machine-readable storage medium 120 and executed by processor 110. The actions may relate to a type of the data element, an identifier of the data element, and/or a policy applicable to the data element.

For a network packet, for example, an action may comprise modifying the packet from a UDP protocol packet to a TCP protocol packet based on a requirement of a destination network for the packet. Similarly, a network packet may be associated with a routing action, such as directing the packet to a particular subnet of a network via a network port associated with device 100. Actions may be identified for intended data elements such as network packets by evaluating certain criteria. For example, criteria may comprise packets associated with a TCP connection, packets from a particular MAC or IP address, packets received from or destined for a particular port, and/or packets with a certain identifier, such as a Virtual Local Area Network (VLAN) tag.

Create action set pointer instructions 132 may create a pointer to an action set comprising a list of the plurality of actions. The actions in the action set may comprise, for example, a linked list of references to executable objects associated with each of the actions. For a network packet, for example, the packet may be processed by a pipeline in device 100 wherein the packet is checked against a series of flow tables. The flow tables may each comprise a plurality of possible actions and criteria for applying those actions to packets. As the packet is evaluated at each flow table in the pipeline, an action may be added to the list of actions to be performed on the packet at the end of the pipeline. Adding the action to the set may comprise adding a reference associated with the entry in the flow table for that action to a linked list structure.

In some implementations, a last reference of the linked list of references may comprise a second pointer to a second action set. For example, a first action set may comprise a set of logging actions applied to all data elements processed by device 100. A second action set may comprise a set of routing actions associated with a VLAN identifier of the packet. By adding the pointer to the second action set at the end of the list of actions of the first action set, the two sets may both be associated with the same data element without a second pointer to the second action set having to be added to a field in the data element.

Associate action set instructions 134 may associate the pointer to the action set with the data element. For example, a table may be used to store an identifier for the data element and a pointer to the action set in a database entry. For another example, a field of the data element may be used to hold the pointer to the action set.

In some implementations, associate action set instructions 134 may associate the reference to the action set with a plurality of other data elements. For example, a pointer to a set of logging actions may be associated with each element processed by device 100, such as each packet entering a network switch. The same pointer may be followed in order to execute the same set of actions each time.

Follow pointer instructions 136 may follow the pointer to retrieve the plurality of actions associated with the data element according to the action set. The pointer may, for example, identify a memory location for a reference to the first action of the action set. In some implementations, follow pointer instructions 136 may further comprise instructions to determine whether the data element is ready for processing with respect to the plurality of actions before performing each of the plurality of actions on the data element. For example, follow pointer instructions 136 may determine whether any more actions are associated with a pipeline for a network packet, such as by determining whether any additional flow tables need to be checked for actions to be applied to the packet.

Perform action instructions 138 may perform each of the plurality of actions on the data element. The reference to the first action retrieved by follow pointer instructions 136 may be used to retrieve an executable object comprising instructions for performing the first action. In some implementations, a link referencing a second action may be associated with the first action, and an executable object for the second action may be similarly retrieved and executed to perform the second action on the data element.

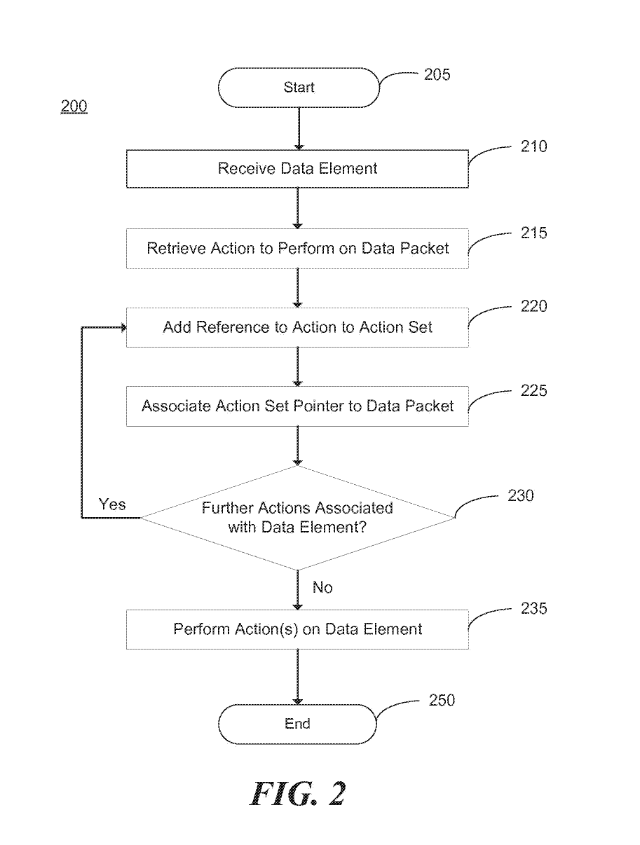

FIG. 2 is a flowchart of a method 200 for action reference consistent with disclosed implementations. Although execution of method 200 is described below with reference to the components of action reference device 100, other suitable components for execution of method 200 may be used.

Method 200 may begin in stage 205 and proceed to stage 210 where device 100 may receive a data element. For example, a network node such as a switch may receive a network packet on an inbound port and/or a storage service may receive data to be stored to a storage device.

Method 200 may then advance to stage 215 where device 100 may retrieve an action to be performed on the data element. For example, a network packet may be associated with a flow in a network node, wherein the flow comprises a pipeline of processing actions to be applied to the packet. The flow may be identified, for example, according to a source or destination port, an identifier for the packet (e.g., a VLAN tag), a protocol type associated with the packet (e.g., UDP, TCP, etc.), and/or a network address associated with the packet (e.g., MAC address and/or IP address associated with a source or destination of the packet).

For example, identify action instructions 130 may identify a plurality of actions associated with a data element. The data element may comprise, for example, a network packet such as may be associated with an OpenFlow-enabled network. The actions may comprise, for example, routing controls, logging instructions, and/or modification instructions (e.g., re-encoding for different network protocols and/or modification of different fields within the data element).

The data element may be evaluated to identify which, if any, actions need to be performed with respect to the data element. The action may be performed by an executable object stored in machine-readable storage medium 120 and executed by processor 110. The actions may relate to a type of the data element, an identifier of the data element, and/or a policy applicable to the data element.

For a network packet, for example, an action may comprise modifying the packet from a UDP protocol packet to a TCP protocol packet based on a requirement of a destination network for the packet. Similarly, a network packet may be associated with a routing action, such as directing the packet to a particular subnet of a network via a network port associated with device 100. Actions may be identified for intended data elements such as network packets by evaluating certain criteria. For example, criteria may comprise packets associated with a TCP connection, packets from a particular MAC or IP address, packets received from or destined for a particular port, and/or packets with a certain identifier, such as a Virtual Local Area Network (VLAN) tag.

Method 200 may then advance to stage 220 where device 100 may add a reference to the action to an action set. For example, the reference to the action may comprise one of a plurality of references to a section of a lookup table, wherein each of the plurality of references is associated with an available action. Each action that may be performed on a data element processed by device 100 may comprise an available action listed in the lookup table.

Method 200 may then advance to stage 225 where device 100 may associate a pointer to the action set with the data element. For example, create action set pointer instructions 132 may create a pointer to an action set comprising a list of the plurality of actions. The actions in the action set may comprise, for example, a linked list of references to executable objects associated with each of the actions. For a network packet, for example, the packet may be processed by a pipeline in device 100 wherein the packet is checked against a series of flow tables. The flow tables may each comprise a plurality of possible actions and criteria for applying those actions to packets. As the packet is evaluated at each flow table in the pipeline, an action may be added to the list of actions to be performed on the packet at the end of the pipeline. Adding the action to the set may comprise adding a reference associated with the entry in the flow table for that action to a linked list structure.

In some implementations, a last reference of the linked list of references may comprise a second pointer to a second action set. For example, a first action set may comprise a set of logging actions applied to all data elements processed by device 100. A second action set may comprise a set of routing actions associated with a VLAN identifier of the packet. By adding the pointer to the second action set at the end of the list of actions of the first action set, the two sets may both be associated with the same data element without a second pointer to the second action set having to be added to a field in the data element.

Associate action set instructions 134 may associate the pointer to the action set with the data element. For example, a table may be used to store an identifier for the data element and a pointer to the action set in a database entry. For another example, a field of the data element may be used to hold the pointer to the action set.

In some implementations, associate action set instructions 134 may associate the reference to the action set with a plurality of other data elements. For example, a pointer to a set of logging actions may be associated with each element processed by device 100, such as each packet entering a network switch. The same pointer may be followed in order to execute the same set of actions each time.

Method 200 may then advance to stage 230 where device 100 may determine whether any further actions are associated with the data element. For example, the data element may have reached the end of a processing pipeline and be ready for an output, storage, or delivery to a destination. For another example, all criteria may have been evaluated such that no further actions need to be added to the action set(s) for the data element.

If further actions are determined to be associated with the data element at stage 230, method 200 may return to stage 220 to add references to those actions to the action set. Otherwise, method 200 may advance to stage 235 where device 100 may perform the action on the data element. For example, device 100 may retrieve the action set by following the pointer to the action set and execute an object at the reference to the action in the action set. Perform action instructions 138 may perform each of the plurality of actions on the data element. The reference to the first action retrieved by follow pointer instructions 136 may be used to retrieve an executable object comprising instructions for performing the first action. In some implementations, a link referencing a second action may be associated with the first action, and an executable object for the second action may be similarly retrieved and executed to perform the second action on the data element.

Method 200 may then end at stage 250.

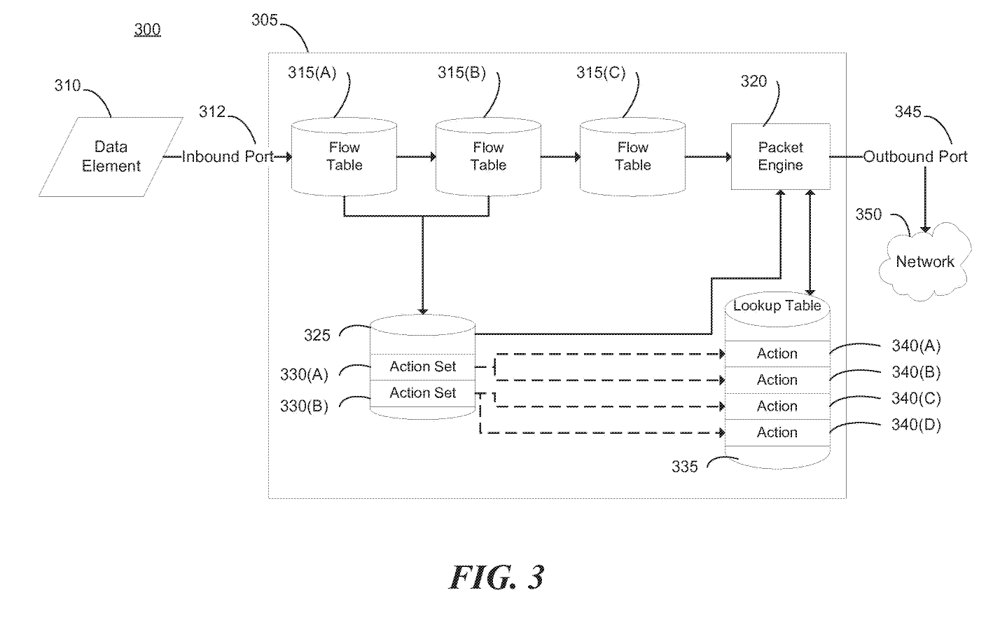

FIG. 3 is a block diagram of an example system 300 for providing action references using flow tables. System 300 may comprise a network node 305, such as a switch, that may receive a data element 310, such as a network packet. Data element 310 may enter network node 305 on an inbound port 312 and into a processing pipeline for a flow comprising a plurality of flow tables 315(A)-(C). Each flow tables 315(A)-(C) may comprise an action and/or a set of actions to be performed if data element 310 matches criteria associated with flow table 315(A)-(C). Actions to be performed on data element 310 may be stored in an element table 325 comprising a plurality of action sets 330(A)-(B) stored as pointers to a list of actions 340(A)-(D) stored as entries in an action lookup table 335.

Once the packet has been compared to criteria at each of the flow tables 315(A)-(C) of the processing pipeline, a packet engine 320 may retrieve and perform the actions. Retrieval may comprise, for example, following a pointer to action set 330(A) stored in a data field of data element 310(A) to a reference address for action 340(A). Packet engine 320 may then dereference the address for action 340(A) to retrieve an executable object that provides instructions to be performed on data element 310, such as creating a copy of a data payload for a log entry. Packet engine 320 may follow a linked list of references in action set 330(A) to retrieve a reference address to the next action, such as action 340(B), and similarly dereference the address and retrieve the executable object for action 340(B). The linked list of actions may comprise a pointer to another action set, such as action set 330(B), which may be similarly followed and the action references contained therein processed as described above. Once all of the actions of action sets 330(A)-(B) have been performed with respect to data element 310, the packet may be output to an outbound port 345 connected to a network 350 for delivery toward its destination.

Packet engine 320 may comprise, for example, any combination of hardware and programming to implement the functionalities described. In some implementations, the programming for the engines may be processor executable instructions stored on a non-transitory machine-readable storage medium and the hardware for the engines may include a processing resource to execute those instructions. For example, the processing pipeline described above may be implemented in a System on Chip (SoC) comprising a processor, an application-specific integrated circuit (ASIC) and/or a memory.

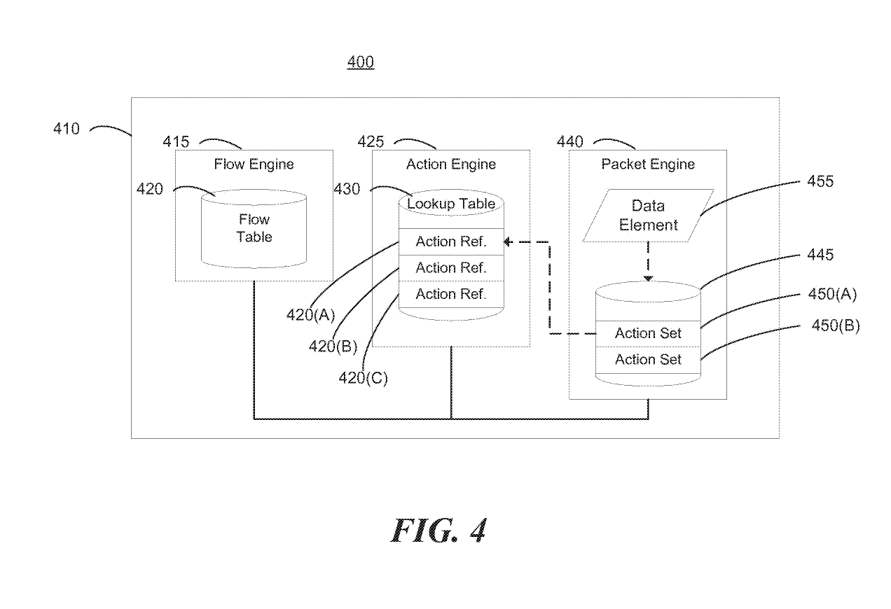

FIG. 4 is a block diagram of an example system 400 for providing action references comprising a computing device 410. Computing device 410 may comprise, for example, a general and/or special purpose computer, server, mainframe, desktop, laptop, tablet, smart phone, game console, and/or any other system capable of providing computing capability consistent with providing the implementations described herein. Computing device 410 may comprise any combination of hardware and programming to implement the functionalities of the respective components. In examples described herein, such combinations of hardware and programming may be implemented in a number of different ways. For example, programming may comprise processor executable instructions stored on a non-transitory machine-readable storage medium and the hardware for the engines may include a processing resource to execute those instructions.

Device 410 may comprise a flow engine 415 comprising a flow table 420, an action engine 425 comprising a lookup table 430 comprising a plurality of action references 435(A)-(C), and a packet engine 440 comprising an action set table 445 comprising a plurality of action sets 450(A)-(B) to be performed on a data packet 455.

Flow engine 415 may create an entry in flow table 420 comprising a packet criteria and at least one action and determine if a data element 455 matches the packet criteria. In response to determining that the data element matches the packet criteria, flow engine 415 may associate a pointer to an action set 450(A) comprising a reference 420(A) to the at least one action with the data element 455 in an action set table 445.

Flow engine 415 may comprise identify action instructions 130 that may identify a plurality of actions associated with a data element 455. The data element 455 may comprise, for example, a network packet such as may be associated with an OpenFlow-enabled network. The actions may comprise, for example, routing controls, logging instructions, and/or modification instructions (e.g., re-encoding for different network protocols and/or modification of different fields within the data element).

The data element 455 may be evaluated to identify which, if any, actions need to be performed with respect to the data element 455. The action may be performed by an executable object stored in a machine-readable storage medium and executed by a processor. The actions may, for example, relate to a type of the data element 455, an identifier of the data element 455, and/or a policy applicable to the data element 455.

For a network packet, for example, an action may comprise modifying the packet from a UDP protocol packet to a TCP protocol packet based on a requirement of a destination network for the packet. Similarly, a network packet may be associated with a routing action, such as directing the packet to a particular subnet of a network via a network port associated with device 100. Actions may be identified for intended data elements such as network packets by evaluating certain criteria. For example, criteria may comprise packets associated with a TCP connection, packets from a particular MAC or IP address, packets received from or destined for a particular port, and/or packets with a certain identifier, such as a Virtual Local Area Network (VLAN) tag.

Flow engine 415 may comprise create action set pointer instructions 132 that may create a pointer to an action set 450(A) comprising a list of the plurality of actions. The actions in the action set may comprise, for example, a linked list of references 420(A)-(C) to executable objects associated with each of the actions. For a network packet, for example, the packet may be processed by a pipeline in device 410 wherein the packet is checked against a series of flow tables. The flow table(s) 420 may each comprise a plurality of possible actions and criteria for applying those actions to packets. As the packet is evaluated at each flow table in the pipeline, an action may be added to the list of actions to be performed on the packet at the end of the pipeline. Adding the action to the action set 450(A) may comprise adding a reference 420(A) associated with the entry in the flow table for that action to a linked list structure.

In some implementations, a last reference of the linked list of references may comprise a second pointer to a second action set 450(B). For example, a first action set may comprise a set of logging actions applied to all data elements processed by device 100. A second action set may comprise a set of routing actions associated with a VLAN identifier of the packet. By adding the pointer to the second action set at the end of the list of actions of the first action set, the two sets may both be associated with the same data element 455 without a second pointer to the second action set having to be added to a field in the data element.

Flow engine 415 may comprise associate action set instructions 134 that may associate the pointer to the action set 450(A) with the data element 455. For example, action set table 445 may be used to store an identifier for the data element 455 and a pointer to the action set 450(A) in a database entry. For another example, a field of the data element 455 may be used to hold the pointer to the action set 450(A).

In some implementations, associate action set instructions 134 may associate the pointer to the action set 450(A) with a plurality of other data elements. For example, a pointer to a set of logging actions may be associated with each element processed by device 410, such as each packet entering a network switch. The same pointer may be followed in order to execute the same set of actions each time.

Action engine 425 may provide lookup table 430 comprising a plurality action references 420(A)-(C), each associated with an executable object and retrieve the executable object associated with a received reference of the plurality of references 420(A)-(C). For example, packet engine 440 may retrieve action reference 420(A) from action set 450(A) and provide it to action engine 425. Action engine 425 may dereference action reference 420(A) to locate a corresponding executable object and provide that object back to packet engine 440.

Packet engine 440 may determine whether any further actions are associated with the data element 455, and if not, perform the at least one action via a corresponding executable object for the reference 420(A) to the at least one action in the action set 450(A).

Packet engine 440 may comprise follow pointer instructions 136 that may follow the pointer to retrieve the plurality of actions associated with the data element 455 according to the action set 450(A). The pointer may, for example, identify a memory location for a reference 420(A) to the first action of the action set 450(A) and/or a memory location for the action set 450(A) in the action set table 445. In some implementations, follow pointer instructions 136 may further comprise instructions to determine whether the data element 455 is ready for processing with respect to the plurality of actions before performing each of the plurality of actions on the data element 455. For example, follow pointer instructions 136 may determine whether any more actions are associated with a pipeline for a network packet, such as by determining whether any additional flow tables 420 need to be checked for actions to be applied to the packet.

Packet engine 440 may comprise perform action instructions 138 that may perform each of the plurality of actions on the data element 455. The reference 420(A) to the first action retrieved by follow pointer instructions 136 may be used to retrieve an executable object comprising instructions for performing the first action. In some implementations, a link referencing a second action 420(B) may be associated with the first action in the action set 450(A), and an executable object for the second action may be similarly retrieved and executed to perform the second action on the data element 455.

The disclosed examples may include systems, devices, computer-readable storage media, and methods for action reference. For purposes of explanation, certain examples are described with reference to the components illustrated in the Figures. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium comprising instructions to:
identify a plurality of actions associated with a data element;
create a pointer to an action set comprising a list of the plurality of actions;
associate the pointer to the action set with the data element;
follow the pointer to retrieve the plurality of actions associated with the data element according to the action set; and
perform each of the plurality of actions on the data element.

2. The non-transitory machine-readable medium of claim 1, wherein the data element comprises a network packet associated with at least one OpenFlow-enabled network.

3. The non-transitory machine-readable medium of claim 2, wherein the plurality of actions comprise at least one routing action and at least one data element modification action.

4. The non-transitory machine-readable medium of claim 2, wherein the instructions to follow the pointer to retrieve the plurality of actions further comprise instructions to:
determine whether the data element is ready for processing with respect to the plurality of actions before performing each of the plurality of actions on the data element, wherein the instructions to determine whether the data element is ready for processing with respect to the plurality of actions comprise instructions to determine whether any more actions are associated with a pipeline for the network packet.

5. The non-transitory machine-readable medium of claim 1, wherein the action set comprises a plurality of executable objects associated with the plurality of actions.

6. The non-transitory machine-readable medium of claim 1, wherein the action set comprises a linked list of references to a plurality of executable objects associated with the plurality of actions.

7. The non-transitory machine-readable medium of claim 5, wherein a last reference of the linked list of references comprises a second pointer to a second action set.

8. The non-transitory machine-readable medium of claim 1, wherein the instructions to associate the pointer to the action set with the data element further comprise instructions to associate the reference to the action set with a plurality of other data elements.

9. A computer-implemented method, comprising:
receiving a data element;
retrieving an action to be performed on the data element;
adding a reference to the action to an action set;
associating a pointer to the action set with the data element;
determining, by a processor, whether any further actions are associated with the data element; and
in response to determining that no further actions are associated with the data element, performing the action on the data element.

10. The computer-implemented method of claim 9, wherein performing the first action on the data element comprises:
retrieving the action set by following the pointer to the action set; and
executing an object at the reference to the action in the action set.

11. The computer-implemented method of claim 8, wherein the action set comprises a second pointer to a second action set.

12. The computer-implemented method of claim 9, wherein retrieving the first action to be performed on the data element comprises identifying a flow associated with an identifier of the data element.

13. The computer-implemented method of claim 12, wherein the flow is associated with at least one of the following: a protocol type, a selected port, a packet identifier, and a network address.

14. The computer implemented method of claim 8, wherein the reference to the action comprises one of a plurality of references to a section of a lookup table, wherein each of the plurality of references is associated with an available action.

15. A system, comprising:
a flow engine to:
create an entry in a flow table comprising a packet criteria and at least one action,
determine if a data element matches the packet criteria, and
in response to determining that the data element matches the packet criteria, associate a pointer to an action set comprising a reference to the at least one action with the data element in an action set table;
an action engine to:
provide a lookup table comprising a plurality of references each associated with an executable object, wherein the reference to the at least one action comprises one of the plurality of references, and
retrieve the executable object associated with a received reference of the plurality of references;
a packet engine to:
determine whether any further actions are associated with the data element, and
in response to determining that no further actions are associated with the data element, perform the at least one action via a corresponding executable object for the reference to the at least one action.
